(19) United States
(12) Patent Application Publication
(10) Pub. No.: US 2017/0256036 A1
(43) Pub. Date: Sep. 7, 2017

(54) AUTOMATIC MICROLENS ARRAY ARTIFACT CORRECTION FOR LIGHT-FIELD IMAGES

(71) Applicant: Lytro, Inc., Mountain View, CA (US)

(72) Inventors: Alex Song, San Jose, CA (US); Yuriy Romanenko, San Jose, CA (US)

(21) Appl. No.: 15/059,657

(22) Filed: Mar. 3, 2016

(51) Int. Cl. G06T 5/00; H04N 5/232; G02B 3/00

(52) U.S. Cl. CPC G06T 5/002; G02B 3/0006; H04N 5/232; G06T 2207/10008

(57) ABSTRACT

According to various embodiments, light-field image data may be processed so as to prevent, remove, and/or mitigate artifacts caused by previous processing steps. A light-field image may first be captured by a light-field camera. One or more processing steps may be applied to the light-field image to generate a processed light-field image having one or more artifacts. A flat white modulation light-field image may also be captured by the light-field camera. The same processing steps previously applied to the light-field image may be applied to the modulation light-field image to generate a processed modulation light-field image with the same artifacts. The artifacts may then be identified in the processed modulation light-field image to generate an identification of the artifacts. This identification may be used to identify the same artifacts in the processed light-field image, which may then be corrected to remove the artifacts to generate a corrected, processed light-field image.

### CROSS-REFERENCE TO RELATED APPLICATIONS

The present application is related to U.S. application Ser. No. 13/774,925 for “Compensating for Sensor Saturation and Microlens Modulation During Light-Field Image Processing” (Atty. Docket No. LYT019), filed Feb. 22, 2013, issued on Feb. 3, 2015 as U.S. Pat. No. 8,948,545, the disclosure of which is incorporated herein by reference in its entirety.

The present application is related to U.S. Utility application Ser. No. 13/774,971 for “Compensating for Variation in Microlens Position During Light-Field Image Processing” (Atty. Docket No. LYT021), filed on Feb. 22, 2013, issued on Sep. 9, 2014 as U.S. Pat. No. 8,831,377, the disclosure of which is incorporated herein by reference in its entirety.

The present application is related to U.S. Utility application Ser. No. 13/867,333 for “Light-Field Based Autofocus” (Atty. Docket No. LYT034), filed on Apr. 22, 2013, the disclosure of which is incorporated herein by reference in its entirety.

The present application is related to U.S. Utility application Ser. No. 13/774,986 for “Light-Field Processing and Analysis, Camera Control, and User Interfaces and Interaction on Light-Field Capture Devices” (Atty. Docket No. LYT066), filed on Feb. 22, 2013, issued on Mar. 31, 2015 as U.S. Pat. No. 8,995,785, the disclosure of which is incorporated herein by reference in its entirety.

The present application is related to U.S. Utility application Ser. No. 13/688,026 for “Extended Depth of Field and Variable Center of Perspective in Light-Field Processing” (Atty. Docket No. LYT003), filed on Nov. 28, 2012, issued on Aug. 19, 2014 as U.S. Pat. No. 8,811,769, the disclosure of which is incorporated herein by reference in its entirety.

The present application is related to U.S. Utility application Ser. No. 11/948,901 for “Interactive Refocusing of Electronic Images,” (Atty. Docket No. LYT3000), filed Nov. 30, 2007, issued on Oct. 15, 2013 as U.S. Pat. No. 8,559,705, the disclosure of which is incorporated herein by reference in its entirety.

The present application is related to U.S. Utility application Ser. No. 12/703,367 for “Light-field Camera Image, File and Configuration Data, and Method of Using, Storing and Communicating Same,” (Atty. Docket No. LYT3003), filed Feb. 10, 2010, now abandoned, the disclosure of which is incorporated herein by reference in its entirety.

The present application is related to U.S. Utility application Ser. No. 13/027,946 for “3D Light-field Cameras, Images and Files, and Methods of Using, Operating, Processing and Viewing Same” (Atty. Docket No. LYT3006), filed on Feb. 15, 2011, issued on Jun. 10, 2014 as U.S. Pat. No. 8,749,620, the disclosure of which is incorporated herein by reference in its entirety.

The present application is related to U.S. Utility application Ser. No. 13/155,882 for “Storage and Transmission of Pictures Including Multiple Frames,” (Atty. Docket No. LYT009), filed Jun. 8, 2011, issued on Dec. 9, 2014 as U.S. Pat. No. 8,908,058, the disclosure of which is incorporated herein by reference in its entirety.

### TECHNICAL FIELD

The present disclosure relates to systems and methods for processing and displaying light-field image data, and more specifically, to systems and methods for removing and/or mitigating artifacts introduced in the processing of light-field images.

### BACKGROUND

Light-field images represent an advancement over traditional two-dimensional digital images because light-field images typically encode additional data for each pixel related to the trajectory of light rays incident to that pixel when the light field image was taken. This data can be used to manipulate the light-field image through the use of a wide variety of rendering techniques that are not possible to perform with a conventional photograph. In some implementations, a light-field image may be refocused and/or altered to simulate a change in the center of perspective (CoP) of the camera that received the image. Further, a light field image may be used to generate an extended depth-of-field (EDOF) image in which all parts of the image are in focus.

In the course of processing light-field images in order to carry out these and other transformations, or to store or display the light-field images, various artifacts may be introduced. Downsampling and filtering are examples of two light-field image processing steps that may result in the production of artifacts. Such artifacts may be caused by the microlens array pattern beating with the repeating nature of the downsampling kernel or the filter. These artifacts may be visible to the user as defects in the light-field images. Known light-field image processing techniques are lacking in effective methods for mitigating and/or removing such artifacts.

### SUMMARY

According to various embodiments, the system and method described herein process light-field image data so as to prevent, remove, and/or mitigate artifacts caused by previous processing steps. These techniques may be used in the processing of light-field images such as a light-field image received from a light-field image capture device having a sensor and a plurality of microlenses.

According to some methods, the light-field image may first be captured in a data store of the light-field image capture device or a separate computing device. One or more processing steps may be applied to the light-field image to generate a processed light-field image having one or more artifacts. A modulation light-field image may also be captured and received in the data store. The modulation light-field image may depict no significant features. The same one or more processing steps previously applied to the light-field image may be applied to the modulation light-field image to generate a processed modulation light-field image with the same artifacts. The artifacts may then be identified in the processed modulation light-field image to generate an identification of the artifacts. This identification may be used to identify the same artifacts in the processed light-field image. The processed light-field image may then be corrected to remove the artifacts to generate a corrected, processed light-field image.

The modulation light-field image may be, for example, a white light-field image of a uniform flat, white scene. The modulation light-field image may optionally be captured with the same light-field image capture device, or camera, used to capture the light-field image to be processed and corrected. In some embodiments, the modulation light-field image may be captured with the same capture settings used to capture the light-field image. The capture settings may include, for example, a zoom setting and/or a focus setting of the light-field camera.

The artifacts may be caused during processing of the light-field image and the modulation light-field image by aliasing of a pattern of microlenses in the microlens array of the camera. Thus, the same artifacts may be present in the processed light-field image and the processed modulation light-field image. Processing of the light-field image may include downsampling the light-field image and/or applying a filter to the light-field image. The same processing step(s) may be applied to the modulation light-field image to reproduce the same artifacts.

Identifying the artifacts in the processed modulation light-field image may include applying an autofocus edge detection algorithm to the processed modulation light-field image. Results of the identification may be much more predictable with the processed modulation light-field image than they would be with the processed light-field image, leading to a more accurate and/or reliable identification of the artifacts that can then be applied to the processed light-field image to facilitate removal of the artifacts.

### BRIEF DESCRIPTION OF THE DRAWINGS

The accompanying drawings illustrate several embodiments. Together with the description, they serve to explain the principles of the embodiments. One skilled in the art will recognize that the particular embodiments illustrated in the drawings are merely exemplary, and are not intended to limit scope.

FIG. 1 depicts a portion of a light-field image.

FIG. 2 depicts an example of an architecture for implementing the methods of the present disclosure in a light-field capture device, according to one embodiment.

FIG. 3 depicts an example of an architecture for implementing the methods of the present disclosure in a post-processing system communicatively coupled to a light-field capture device, according to one embodiment.

FIG. 4 depicts an example of an architecture for a light-field camera for implementing the methods of the present disclosure according to one embodiment.

FIG. 5 is a flow diagram depicting a method of correcting a light-field image, according to one embodiment.

FIG. 6 is a screenshot diagram depicting an example of a light-field image, according to one embodiment.

FIG. 7 is a screenshot diagram depicting an example of a modulation light-field image, according to one embodiment.

FIG. 8 is a screenshot diagram depicting the light-field image of FIG. 6, after application of a downsampling process to generate a downsampled light-field image, according to one embodiment.

FIG. 9 is a screenshot diagram depicting the modulation light-field image of FIG. 7, after application of a downsampling process to generate a downsampled modulation light-field image, according to one embodiment.

FIG. 10 is a screenshot diagram depicting the downsampled light-field image of FIG. 8, after the further application of a high pass filter to generate a processed light-field image, according to one embodiment.

FIG. 11 is a screenshot diagram depicting the downsampled modulation light-field image of FIG. 9, after the further application of a high pass filter to generate a processed modulation light-field image, according to one embodiment.

FIG. 12 is a screenshot diagram depicting the processed light-field image of FIG. 10, after removal of the artifacts identified in the processed modulation light-field image of FIG. 11 to generate a corrected, processed light-field image, according to one embodiment.

FIG. 13 is a split screenshot diagram depicting the processed light-field image of FIG. 10 and the corrected, processed light-field image of FIG. 12.

### DEFINITIONS

For purposes of the description provided herein, the following definitions are used:
Artifact: a defect in an image arising from application of one or more image processing steps and/or hardware components of a light-field camera.
Corrected, processed light-field image: the resulting image after a processed light-field image has been corrected to remove artifacts introduced by processing.
Data store: a hardware element that provides volatile or nonvolatile digital data storage.
Disk: a region in a light-field image that is illuminated by light passing through a single microlens; may be circular or any other suitable shape.
Extended depth of field (EDOF) image: an image that has been processed to have objects in focus along a greater depth range.
Identification: a description indicating the location, configuration, and/or other characteristics of one or more artifacts.
Image: a two-dimensional array of pixel values, or pixels, each specifying a color.
Image sensor: a sensor that produces electrical signals in proportion to light received.
Light-field image: an image that contains a representation of light field data captured at the sensor.
Microlens: a small lens, typically one in an array of similar microlenses.
Microlens array: a pattern of microlenses.
Modulation image: a reference image of simple or repetitive subject matter that can be used to facilitate recognition of artifacts.
Processed light-field image: the resulting image after one or more processing steps are applied to a light-field image.
Processed modulation light-field image: the resulting image after one or more processing steps are applied to a modulation light-field image.
Process step: application of an algorithm to modify an image.

In addition, for ease of nomenclature, the term “camera” is used herein to refer to an image capture device or other data acquisition device. Such a data acquisition device can be any device or system for acquiring, recording, measuring, estimating, determining and/or computing data representative of a scene, including but not limited to two-dimensional image data, three-dimensional image data, and/or light-field data. Such a data acquisition device may include optics, sensors, and image processing electronics for acquiring data representative of a scene, using techniques that are well known in the art. One skilled in the art will recognize that many types of data acquisition devices can be used in connection with the present disclosure, and that the disclosure is not limited to cameras. Thus, the use of the term “camera” herein is intended to be illustrative and exemplary, but should not be considered to limit the scope of the disclosure. Specifically, any use of such term herein should be considered to refer to any suitable device for acquiring image data.

In the following description, several techniques and methods for processing light-field images are described. One skilled in the art will recognize that these various techniques and methods can be performed singly and/or in any suitable combination with one another.

### Architecture

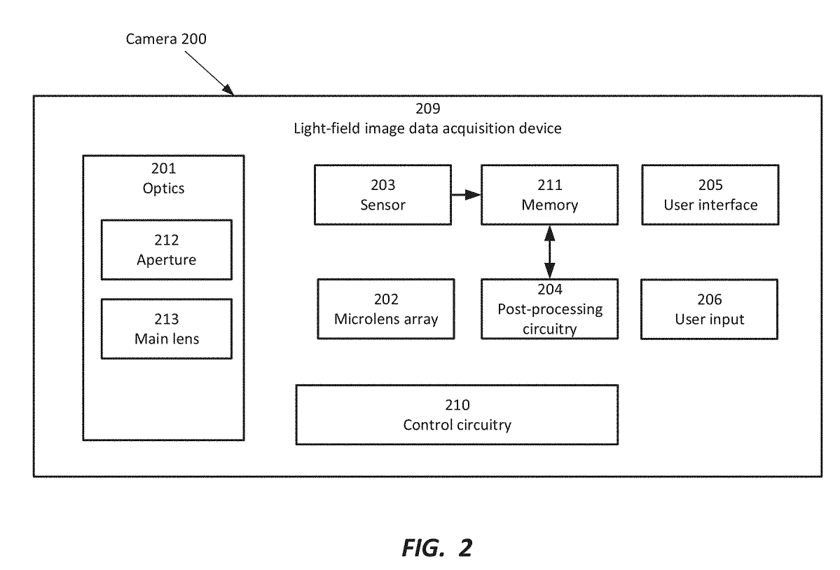

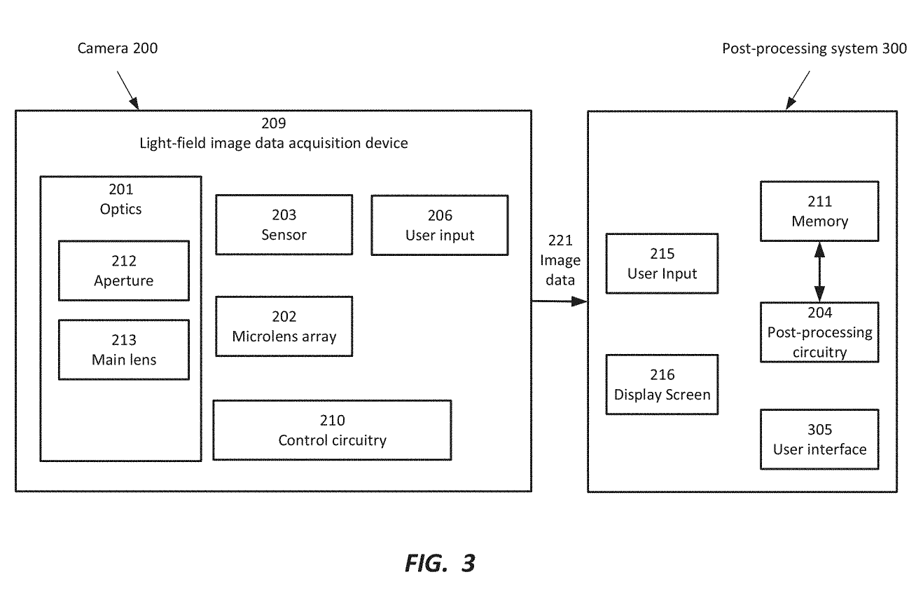

In at least one embodiment, the system and method described herein can be implemented in connection with light-field images captured by light-field capture devices including but not limited to those described in Ng et al., Light-field photography with a hand-held plenoptic capture device, Technical Report CSTR 2005-02, Stanford Computer Science. Referring now to FIG. 2, there is shown a block diagram depicting an architecture for implementing the method of the present disclosure in a light-field capture device such as a camera 200. Referring now also to FIG. 3, there is shown a block diagram depicting an architecture for implementing the method of the present disclosure in a post-processing system 300 communicatively coupled to a light-field capture device such as a camera 200, according to one embodiment. One skilled in the art will recognize that the particular configurations shown in FIGS. 2 and 3 are merely exemplary, and that other architectures are possible for camera 200. One skilled in the art will further recognize that several of the components shown in the configurations of FIGS. 2 and 3 are optional, and may be omitted or reconfigured.

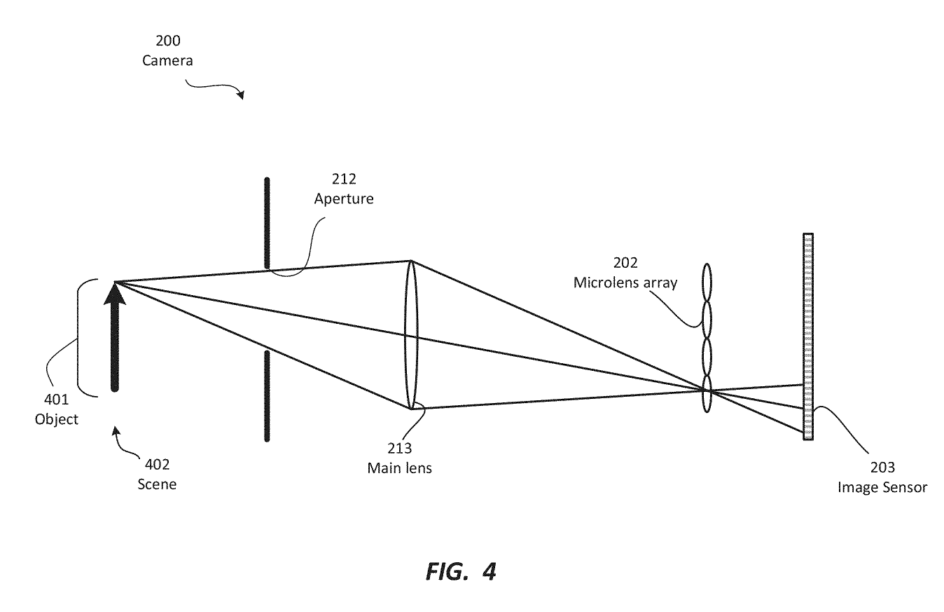

In at least one embodiment, camera 200 may be a light-field camera that includes light-field image data acquisition device 209 having optics 201, image sensor 203 (including a plurality of individual sensors for capturing pixels), and microlens array 202. Optics 201 may include, for example, aperture 212 for allowing a selectable amount of light into camera 200, and main lens 213 for focusing light toward microlens array 202. In at least one embodiment, microlens array 202 may be disposed and/or incorporated in the optical path of camera 200 (between main lens 213 and image sensor 203) so as to facilitate acquisition, capture, sampling of, recording, and/or obtaining light-field image data via image sensor 203. Referring now also to FIG. 4, there is shown an example of an architecture for a light-field camera, or camera 200, for implementing the method of the present disclosure according to one embodiment. The Figure is not shown to scale. FIG. 4 shows, in conceptual form, the relationship between aperture 212, main lens 213, microlens array 202, and image sensor 203, as such components interact to capture light-field data for one or more objects, represented by an object 401, which may be part of a scene 402.

In at least one embodiment, camera 200 may also include a user interface 205 for allowing a user to provide input for controlling the operation of camera 200 for capturing, acquiring, storing, and/or processing image data. The user interface 205 may receive user input from the user via an input device 206, which may include any one or more user input mechanisms known in the art. For example, the input device 206 may include one or more buttons, switches, touch screens, gesture interpretation devices, pointing devices, and/or the like.

Similarly, in at least one embodiment, post-processing system 300 may include a user interface 305 that allows the user to initiate processing, viewing, and/or other output of light-field images. The user interface 305 may additionally or alternatively facilitate the receipt of user input from the user to establish one or more parameters of subsequent image processing.

In at least one embodiment, camera 200 may also include control circuitry 210 for facilitating acquisition, sampling, recording, and/or obtaining light-field image data. For example, control circuitry 210 may manage and/or control (automatically or in response to user input) the acquisition timing, rate of acquisition, sampling, capturing, recording, and/or obtaining of light-field image data.

In at least one embodiment, camera 200 may include memory 211 for storing image data, such as output by image sensor 203. Such memory 211 can include external and/or internal memory. In at least one embodiment, memory 211 can be provided at a separate device and/or location from camera 200.

For example, camera 200 may store raw light-field image data, as output by image sensor 203, and/or a representation thereof, such as a compressed image data file. In addition, as described in related U.S. Utility application Ser. No. 12/703,367 for “Light-field Camera Image, File and Configuration Data, and Method of Using, Storing and Communicating Same,” (Atty. Docket No. LYT3003), filed Feb. 10, 2010 and incorporated herein by reference in its entirety, memory 211 can also store data representing the characteristics, parameters, and/or configurations (collectively “configuration data”) of device 209. The configuration data may include light-field image capture parameters such as zoom and focus settings.

In at least one embodiment, captured image data is provided to post-processing circuitry 204. The post-processing circuitry 204 may be disposed in or integrated into light-field image data acquisition device 209, as shown in FIG. 2, or it may be in a separate component external to light-field image data acquisition device 209, as shown in FIG. 3. Such separate component may be local or remote with respect to light-field image data acquisition device 209. Any suitable wired or wireless protocol can be used for transmitting image data 221 to circuitry 204; for example, the camera 200 can transmit image data 221 and/or other data via the Internet, a cellular data network, a Wi-Fi network, a Bluetooth communication protocol, and/or any other suitable means.

Such a separate component may include any of a wide variety of computing devices, including but not limited to computers, smartphones, tablets, cameras, and/or any other device that processes digital information. Such a separate component may include additional features such as a user input 215 and/or a display screen 216. If desired, light-field image data may be displayed for the user on the display screen 216.

### Overview

Light-field images often include a plurality of projections (which may be circular or of other shapes) of aperture 212 of camera 200, each projection taken from a different vantage point on the camera's focal plane. The light-field image may be captured on image sensor 203. The interposition of microlens array 202 between main lens 213 and image sensor 203 causes images of aperture 212 to be formed on image sensor 203, each microlens in microlens array 202 projecting a small image of main-lens aperture 212 onto image sensor 203. These aperture-shaped projections are referred to herein as disks, although they need not be circular in shape. The term “disk” is not intended to be limited to a circular region, but can refer to a region of any shape.

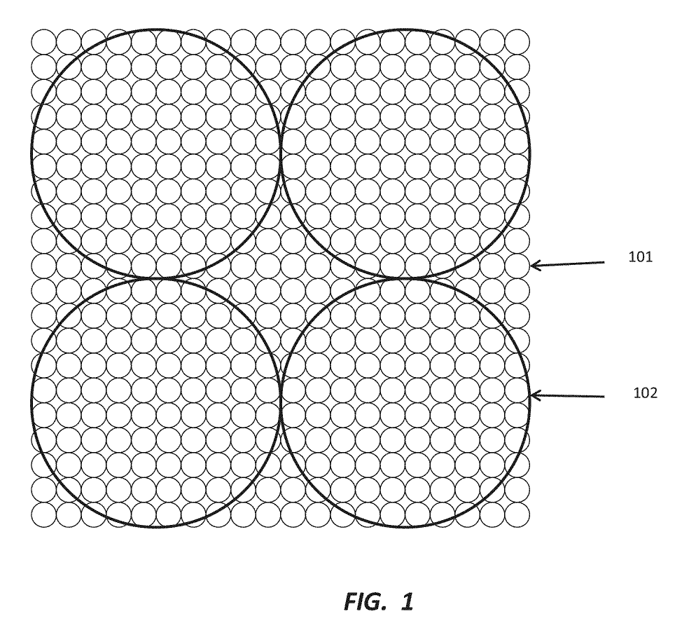

Light-field images include four dimensions of information describing light rays impinging on the focal plane of camera 200 (or other capture device). Two spatial dimensions (herein referred to as x and y) are represented by the disks themselves. For example, the spatial resolution of a light-field image with 120,000 disks, arranged in a Cartesian pattern 400 wide and 300 high, is 400×300. Two angular dimensions (herein referred to as u and v) are represented as the pixels within an individual disk. For example, the angular resolution of a light-field image with 100 pixels within each disk, arranged as a 10×10 Cartesian pattern, is 10×10. This light-field image has a 4-D (x,y,u,v) resolution of (400,300,10,10). Referring now to FIG. 1, there is shown an example of a 2-disk by 2-disk portion of such a light-field image, including depictions of disks 102 and individual pixels 101; for illustrative purposes, each disk 102 is ten pixels 101 across.

In at least one embodiment, the 4-D light-field representation may be reduced to a 2-D image through a process of projection and reconstruction. As described in more detail in related U.S. Utility application Ser. No. 13/774,971 for “Compensating for Variation in Microlens Position During Light-Field Image Processing,” (Atty. Docket No. LYT021), filed Feb. 22, 2013, the disclosure of which is incorporated herein by reference in its entirety, a virtual surface of projection may be introduced, and the intersections of representative rays with the virtual surface can be computed. The color of each representative ray may be taken to be equal to the color of its corresponding pixel.

Any number of image processing techniques can be used to reduce color artifacts, reduce projection artifacts, increase dynamic range, and/or otherwise improve image quality. Examples of such techniques, including for example modulation, demodulation, and demosaicing, are described in related U.S. application Ser. No. 13/774,925 for “Compensating for Sensor Saturation and Microlens Modulation During Light-Field Image Processing” (Atty. Docket No. LYT019), filed Feb. 22, 2013, the disclosure of which is incorporated herein by reference in its entirety.

Some image processing techniques may introduce artifacts into the processed light-field image. In particular, processing steps such as downsampling and application of a filter may be used in the course of implementation of an autofocus algorithm. Various software-based methods for carrying out autofocusing are described in Utility application Ser. No. 13/867,333 for “Light-Field Based Autofocus,” referenced above and incorporated by reference herein. The artifacts may inhibit proper performance of autofocusing because the autofocus algorithm may key onto artifacts instead of referencing actual objects in the scene. Accordingly, it is desirable to correct the light-field image to remove the artifacts. Further, post-processing techniques may also introduce artifacts that may beneficially be removed from the light-field image to be viewed by the user.

### Correction of Processed Light-Field Images

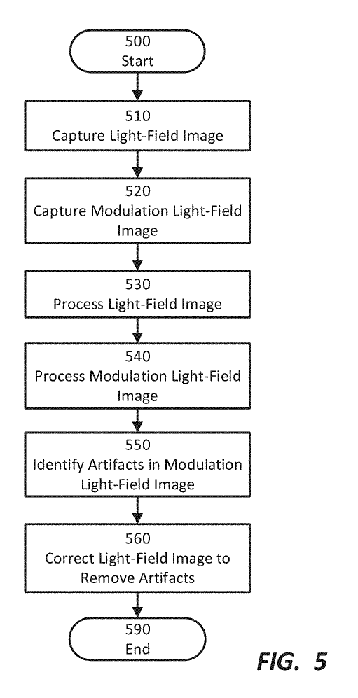

As mentioned above, various image processing steps may be used to process light-field images for various reasons, including preparation of the light-field image for implementation of an autofocus algorithm, resulting in the introduction of artifacts into the processed light-field image. A processed light-field image may be corrected to remove the artifacts through the use of a modulation light-field image. The result may be the provision of a corrected, processed light-field image in which the artifacts are mitigated and/or removed. One method for accomplishing this will be shown and described in connection with FIG. 5.

FIG. 5 is a flow diagram depicting a method of correcting a light-field image, according to one embodiment. The method may be performed, for example, with circuitry such as the post-processing circuitry 204 of the camera 200 of FIG. 2 or the post-processing circuitry 204 of the post-processing system 300 of FIG. 3, which is independent of the camera 200. In some embodiments, a computing device may carry out the method; such a computing device may include one or more of desktop computers, laptop computers, smartphones, tablets, cameras, and/or other devices that process digital information.

The method may start 500 with a step 520 in which a light-field image is captured, for example, by the image sensor 203 of the camera 200. Light may pass from the object 401 through the aperture 212, through the main lens 213 and through the microlens array 202 to be recorded by the image sensor 203 as a light-field image. The manner in which the microlens array 202 disperses light received by the image sensor 203 may encode light-field data into the light-field image. The light-field image captured in the step 510 may be a preliminary light-field image to be used by the camera 200 to facilitate the performance of autofocus functionality, as described above and in Utility application Ser. No. 13/867,333 for “Light-Field Based Autofocus,” (Atty. Docket No. LYT034), referenced above and incorporated by reference herein. Thus, the light-field image captured in the step 510 need not necessarily be the light-field image that is ultimately presented to the user, but may rather represent a preliminary step in the capture of that image.

In a step 520, a modulation light-field image may be captured, for example, by the camera 200 as described in connection with the step 510. The modulation light-field image may be an image that is computed from a flat-field image by normalizing based on average values (per color channel), as set forth in U.S. application Ser. No. 13/774,925 for “Compensating for Sensor Saturation and Microlens Modulation During Light-Field Image Processing,”” (Atty. Docket No. LYT019), referenced above and incorporated by reference herein.

Specifically, the modulation image may have pixel values that are the modulation values corresponding to each pixel in a light-field image, and may be computed by imaging a scene with uniform radiance. To ensure numerically accurate results, EV and scene radiance may be adjusted so that pixels with maximum irradiance have normalized values near 0.5. Such a light-field image may be referred to as a flat-field image. The average pixel value of this flat-field image may be computed. The modulation value for each pixel in the modulation image may then be computed as the value of the corresponding pixel in the flat-field image, divided by the average pixel value of the flat-field image.

Capture of the modulation light-field image may be carried out, for example, by imaging a flat, uniformly-illuminated surface. In the alternative to capturing the modulation light-field image and/or performing the modification steps set forth above, the modulation light-field image may be generated by simply assigning values to the pixels of the modulation image in accordance with a pre-established pattern. In either case, the modulation light-field image may have generally uniform luminance, which may make any artifacts introduced into the modulation light-field image relatively easy to locate, as they need not be distinguished from any visible objects. Other modulation image types may alternatively be used.

The modulation light-field image may beneficially be captured or generated with settings similar or identical to those used in the step 510 to capture the light-field image. For example, the light-field image may be captured with a particular zoom setting and a particular focus setting. These same zoom and focus settings may be used in the capture or generation of the modulation light-field image so that subsequent processing steps can be expected to have identical effects on the light-field image and the modulation light-field image, thereby producing the same artifacts in both images.

Notably, the step 520 need not be carried out after the step 510. According to some examples, the modulation light-field image may be captured and/or generated in the course of manufacturing and/or calibrating the camera 200. Thus, when the light-field image is captured in the step 510, the modulation light-field image may already be present, for example, in the memory 211 of the camera 200.

Further, the camera 200 may thus store a library of modulation light-field images at various combinations of settings of the camera 200. For example, a modulation light-field image may be captured at each available zoom and focus combination of the camera 200. These modulation light-field images may be stored in the memory 211 of the camera 200. When a processed light-field image is to be corrected, the modulation light-field image with the appropriate zoom and focus levels may be retrieved and used for subsequent processing steps. The modulation light-field image may have the same zoom and focus levels as the processed light-field image. In the alternative, approximations of these zoom and/or focus levels may be used. For example, if modulation light-field images have been previously captured and recorded at a number of discrete focus and zoom combinations, the modulation light-field image captured with the closest zoom and/or focus levels to those of the processed light-field image may be retrieved and used for the subsequent processing steps.

In a step 530, the light-field image may be processed. The step 530 may include the performance of one or more processing steps. As indicated previously, these may be processing steps that prepare the light-field image for use with a software-based autofocus algorithm or the like. The software-based algorithm may beneficially be performed on a processed light-field image that has been, for example, downsampled and/or filtered. Thus, performance of the step 530 may entail applying a downsampling process, a filtering process, and/or other processing steps to the light-field image. The result may be the generation of a processed light-field image.

The processed light-field image may have artifacts introduced in the processing. These artifacts may be caused by the pattern of microlenses in the microlens array 202 beating with the repeating nature of the processing step(s) applied, for example, the repetitive nature of a downsampling kernel or filter. Such artifacts may beneficially be corrected prior to application of the autofocus algorithm to ensure that they are not mistaken for object transitions or other depth-based features.

In a step 540, the modulation light-field image may also be processed. The same processing step(s) applied to the light-field image may also be applied to the modulation light-field image. The result may be the production of the same artifacts in the modulation light-field image. However, in the modulation light-field image, these artifacts may be much more readily identified, as they need not be distinguished from objects.

Like the step 520, the step 540 need not be performed in the sequence illustrated in FIG. 5. If multiple modulation light-field images have been captured and/or generated and stored, it may be desirable to perform the step 540 before the step 530, and even possibly before the step 510.

For example, the step 540 may be performed by processing the modulation light-field image previously captured for each zoom and focus combination of the camera 200. This may be done, for example, during the manufacture and/or calibration of the camera 200 so that, before the light-field image is captured, any needed processed modulation light-field images have already been generated. These processed modulation light-field images may be stored on the memory 211 of the camera 200 in addition to or in the alternative to storage of the modulation light-field images, as described above. When a processed light-field image is to be corrected, the proper processed modulation light-field image (i.e., the processed modulation light-field image derived from the modulation light-field image captured at or nearest to the zoom and focus combination used to capture the light-field image to be processed) may be retrieved and used in subsequent process steps.

In a step 550, one or more of the artifacts may be identified in the processed modulation light-field image. This may be done through the use of various feature recognition algorithms or the like. Such algorithms may be calibrated to identify features of the processed modulation light-field image that should not be present in a flat-field image. Such algorithms may further be designed to identify the type of defects likely to be caused by the processing step(s) applied in the step 530 and the step 540. For example, horizontal and/or vertical aliasing lines may be identified.

Performance of the step 550 may result in the generation of an identification of the artifacts in the processed modulation light-field image. The identification may contain any information needed to compensate for the artifacts. Accordingly, the identification may indicate the location, magnitude, size, color offset, intensity offset, and/or other characteristics that define the artifacts. Since the light-field image and the modulation light-field image were captured with the same settings and were subjected to the same processing step(s), the resulting processed light-field image and processed modulation light-field image may have the same artifacts. Accordingly, the identification generated in the step 550 may also identify the artifacts introduced into the processed light-field image in the course of processing the light-field image in the step 530.

Like the steps 520 and 540, the step 550 need not be performed in the sequence illustrated in FIG. 5. If multiple modulation light-field images have been captured and/or generated and stored, it may be desirable to perform the step 550 before the step 530, and even possibly before the step 510.

For example, the step 550 may be performed by identifying artifacts in the processed modulation light-field images previously generated for the modulation light-field images for each zoom and focus combination of the camera 200. This may be done, for example, during the manufacture and/or calibration of the camera 200 so that, before the light-field image is captured, any needed identifications for artifacts in the processed modulation light-field images have already been obtained. These identifications may be stored on the memory 211 of the camera 200 in addition to or in the alternative to storage of the processed modulation light-field images or the modulation light-field images, as described above. When a processed light-field image is to be corrected, the proper identification (i.e., the identification for the processed modulation light-field image derived from the modulation light-field image captured at or nearest to the zoom and focus combination used to capture the light-field image to be processed) may be retrieved and used in subsequent process steps.

In a step 560, the processed light-field image may be corrected to remove the artifacts. This correction process may entail using the identification generated in the step 550 to correct the pixel values of the processed light-field image to the values that would have been present if the artifacts had not been introduced. Thus, the color and/or intensity of each affected pixel may be adjusted as needed. For example, the identification may specify the color and/or intensity offset of each artifact-affected pixel of the processed modulation light-field image; the reverse (i.e., compensating) offset may be applied to each pixel of the processed light-field image to remove the artifacts.

The result may be the generation of a corrected, processed light-field image in which the artifacts introduced in the step 530 have been mitigated and/or removed. Compared with the processed light-field image, the corrected, processed light-field image may be more suitable for use in subsequent processes, such as application of an auto-focus algorithm. Additionally or alternatively, in the event that the correction of the light-field image was made to prepare the light-field image for viewing by a user, the corrected processed light-field image may provide a more enjoyable viewing experience due to the absence and/or mitigation of the artifacts introduced during processing. The method may end 590. Further processing of the corrected, processed light-field image may optionally be undertaken to apply autofocus or other algorithms, further prepare the corrected, processed light-field image for viewing by a user, and/or the like.

The various steps of the method of FIG. 5 may be altered, replaced, omitted, and/or reordered in various ways. In some embodiments, the method may be performed in conjunction with other image processing techniques. Thus, the method of FIG. 5 is merely exemplary, and a wide variety of alternative methods may be used within the scope of the present disclosure.

### EXAMPLE

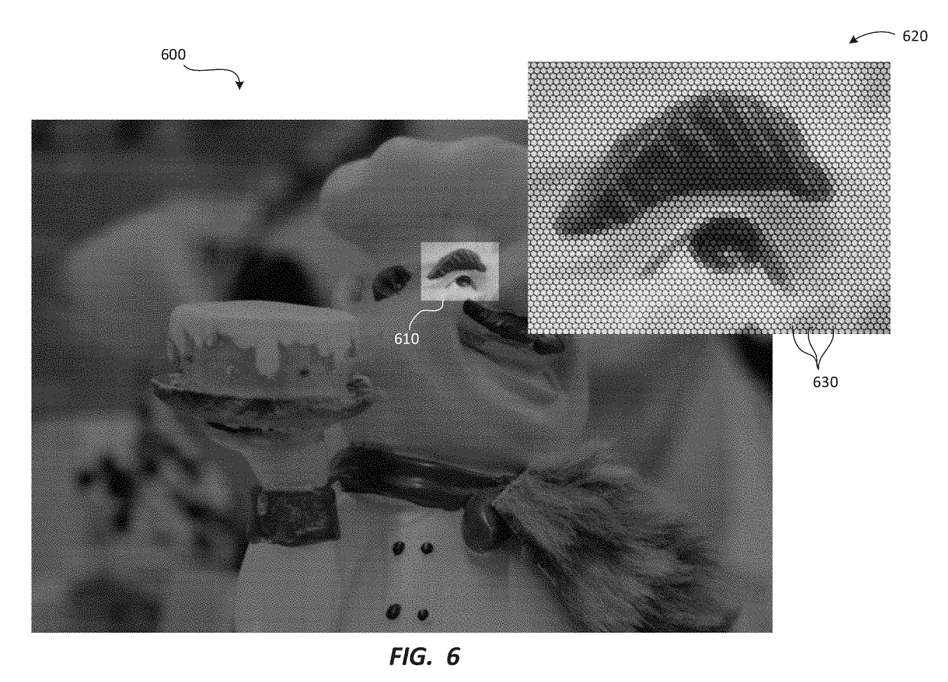

FIGS. 6 through 13 illustrate performance of the method of FIG. 5, according to one embodiment. FIGS. 6 through 13 illustrate the processing of a light-field image to prepare the light-field image for application of a software-based autofocus algorithm, such as that of Utility application Ser. No. 13/867,333 for “Light-Field Based Autofocus,” referenced above and incorporated by reference herein. However, the systems and methods of the present disclosure may be used to provide image correction to facilitate various other image processing techniques.

FIG. 6 is a screenshot diagram depicting an example of a light-field image 600, according to one embodiment. The light-field image 600 may be captured by a light-field image capture device such as the camera 200 of FIG. 2, pursuant to the step 510 of the method of FIG. 5.

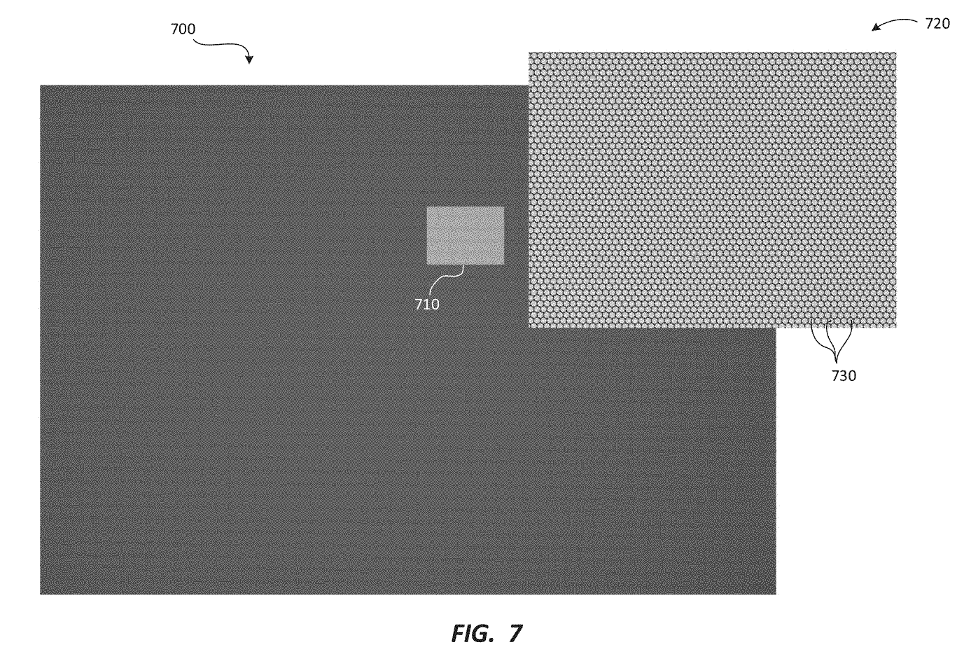

An inset portion 610 of the light-field image 600 is illustrated in an enlarged view 620 to illustrate a higher level of detail. The pattern of light received by the microlenses of the microlens array 202 is visible as a two-dimensional array of circles 630 arranged in the same pattern as the microlenses of the microlens array 202. The enlarged view 620 shows that few if any significant artifacts are present in the light-field image 600. Notably, FIGS. 6 and 7 as presented here may have some visible artifacts due to the downsampling inherent in the process of converting them into patent drawings. However, the raw light-field images represented by FIGS. 6 and 7 may not have been through such downsampling, and may thus have no artifacts.

The light-field image 600 may be captured as part of a software-based autofocus algorithm as described above, and may undergo processing in order to facilitate application of the algorithm. This processing may take the form of downsampling and filtering, as will be described below.

FIG. 7 is a screenshot diagram depicting an example of a modulation light-field image 700, according to one embodiment. The modulation light-field image 700 may be captured by a light-field image capture device such as the camera 200 of FIG. 2, pursuant to the step 520 of the method of FIG. 5. Additionally or alternatively, the modulation light-field image 700 may be modified and/or generated as described above so that it is substantially a flat-field image.

An inset portion 710 of the modulation light-field image 700 is illustrated in an enlarged view 720 to illustrate a higher level of detail. As in the light-field image 600, the pattern of light received by the microlenses of the microlens array 202 is visible as a two-dimensional array of circles 730 arranged in the same pattern as the microlenses of the microlens array 202. The enlarged view 720 shows that, as in the light-field image 600, no significant artifacts are present in the modulation light-field image 700. The modulation light-field image 700 may be captured during the manufacture and/or calibration of the camera 200 as described above, if desired. The modulation light-field image 700 may be captured and/or generated at the zoom and/or focus settings used for capture of the light-field image 600.

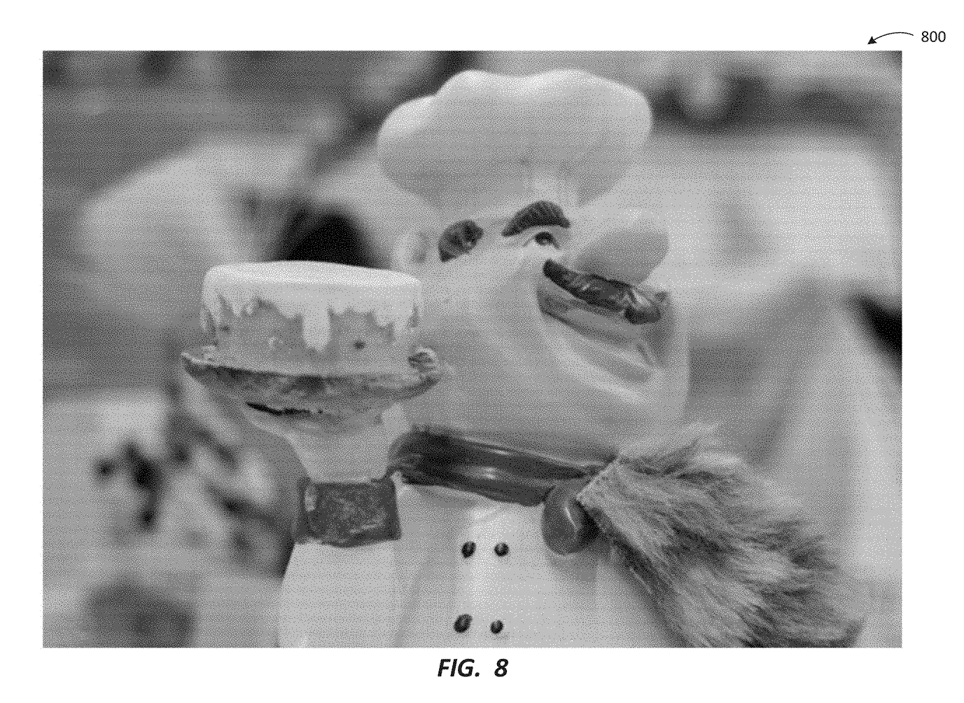

FIG. 8 is a screenshot diagram depicting the light-field image 600 of FIG. 6, after application of a downsampling process to generate a downsampled light-field image 800, according to one embodiment. The downsampled light-field image 800 may be generated pursuant to the step 530 of the method of FIG. 5.

The downsampling process may reduce the pixel count of the downsampled light-field image 800, by comparison with the light-field image 600, so that the downsampled light-field image 800 can be more easily and rapidly processed. Any number of downsampling algorithms may be used to produce the downsampled light-field image 800. The downsampling process may introduce artifacts in the form of horizontal and vertical gridlines, as shown in the downsampled light-field image 800, which may be caused by beating of the downsampling kernel with the pattern of microlenses in the microlens array 202.

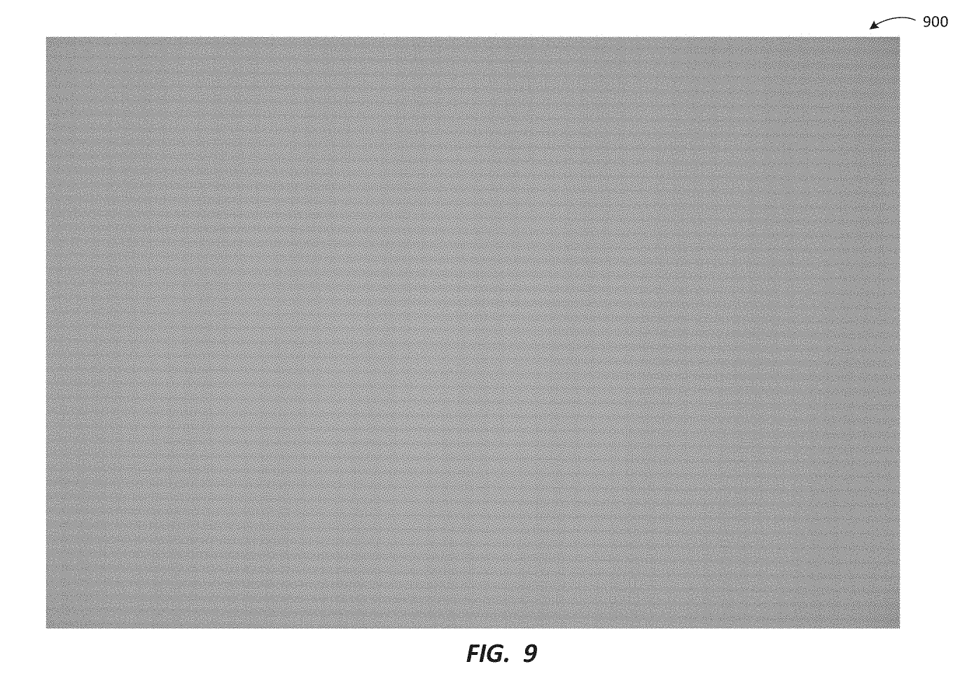

FIG. 9 is a screenshot diagram depicting the modulation light-field image 700 of FIG. 7, after application of a downsampling process to generate a downsampled modulation light-field image 900, according to one embodiment. The downsampled modulation light-field image 900 may be generated pursuant to the step 540 of the method of FIG. 5.

The same downsampling kernel and settings applied to the light-field image 600 to generate the downsampled light-field image 800 of FIG. 8 may be applied to the modulation light-field image 700 to generate the downsampled modulation light-field image 900. Consequently, the downsampled modulation light-field image 900 may have the same artifacts as those introduced into the downsampled light-field image 800, which may be horizontal and vertical gridlines, as shown in the downsampled modulation light-field image 900.

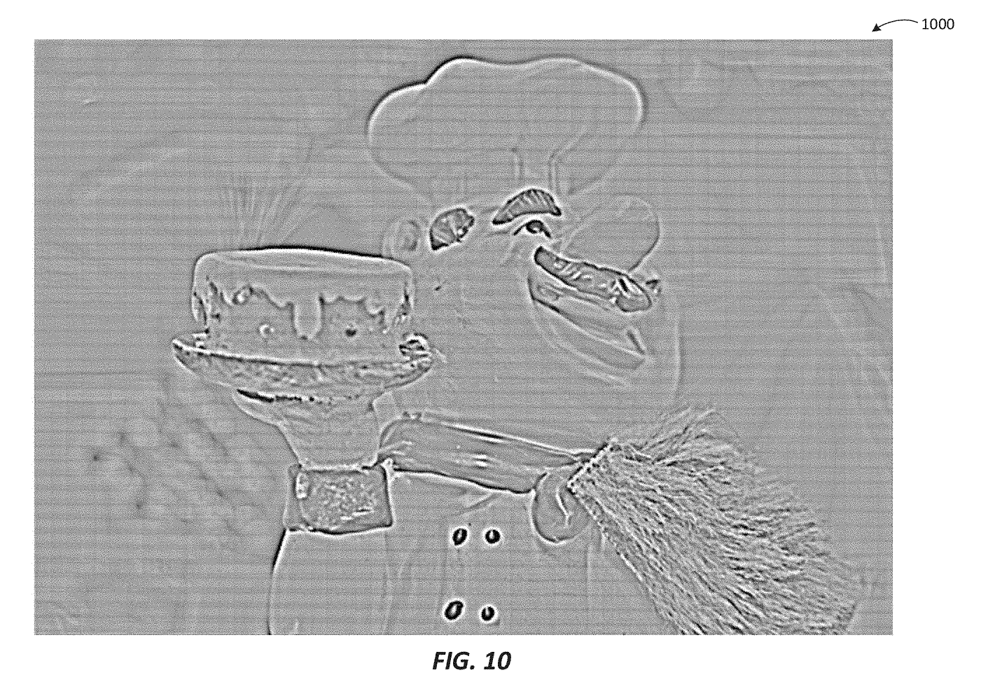

FIG. 10 is a screenshot diagram depicting the downsampled light-field image 800 of FIG. 8, after the further application of a high pass filter to generate a processed light-field image 1000, according to one embodiment. The processed light-field image 1000 may also be generated pursuant to the step 530 of the method of FIG. 5.

The filtering process may include application of a high pass filter, by which pixels that are brighter than their immediate neighbors are boosted in intensity. This may cause features within the processed light-field image 1000 to stand out relatively clearly relative to each other, facilitating the application of algorithms that identify the boundaries between objects. Any number of filtering algorithms may be used. The filtering process may introduce additional artifacts in the light-field image 1000, in addition to those introduced in the downsampling process.

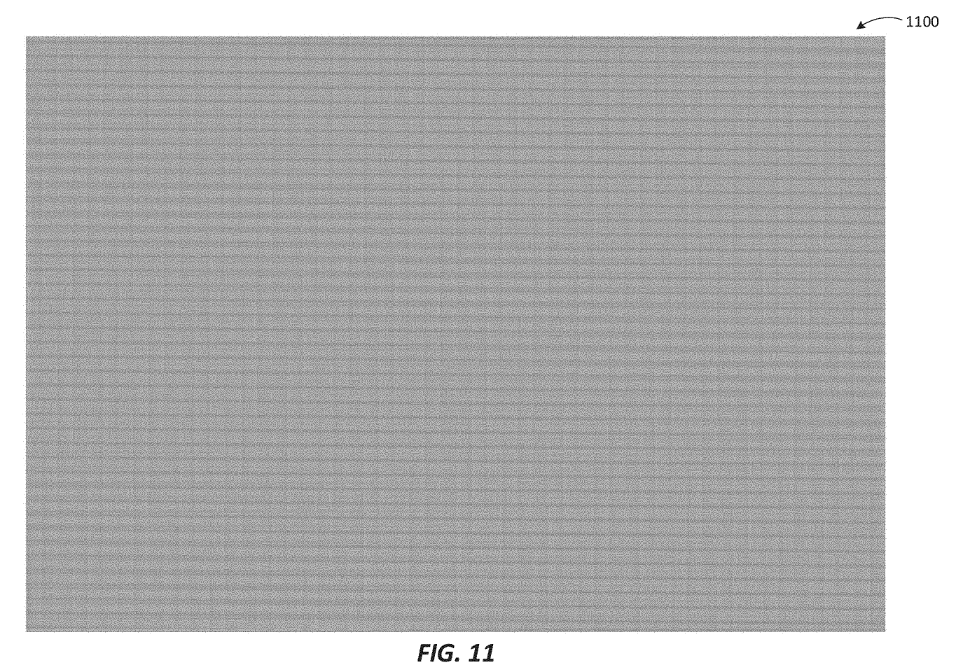

FIG. 11 is a screenshot diagram depicting the downsampled modulation light-field image 900 of FIG. 9, after the further application of a high pass filter to generate a processed modulation light-field image 1100, according to one embodiment. The processed modulation light-field image 1100 may also be generated pursuant to the step 540 of the method of FIG. 5.

The same high pass filter and settings applied to the downsampled light-field image 800 to generate the processed light-field image 1000 of FIG. 10 may be applied to the downsampled modulation light-field image 900 to generate the processed modulation light-field image 1100. Consequently, the processed modulation light-field image 1100 may have the same artifacts as those introduced into the processed light-field image 1000, which may include artifacts introduced in the downsampling and filtering processes. These artifacts may be identified pursuant to the step 550 of the method of FIG. 5. Identification of the artifacts in the processed modulation light-field image 1100 may be relatively easy due to the absence of objects or significant intensity changes other than those introduced in the processing steps used to generate the processed modulation light-field image 1100. Any known technique for identifying image irregularities or defects may be used.

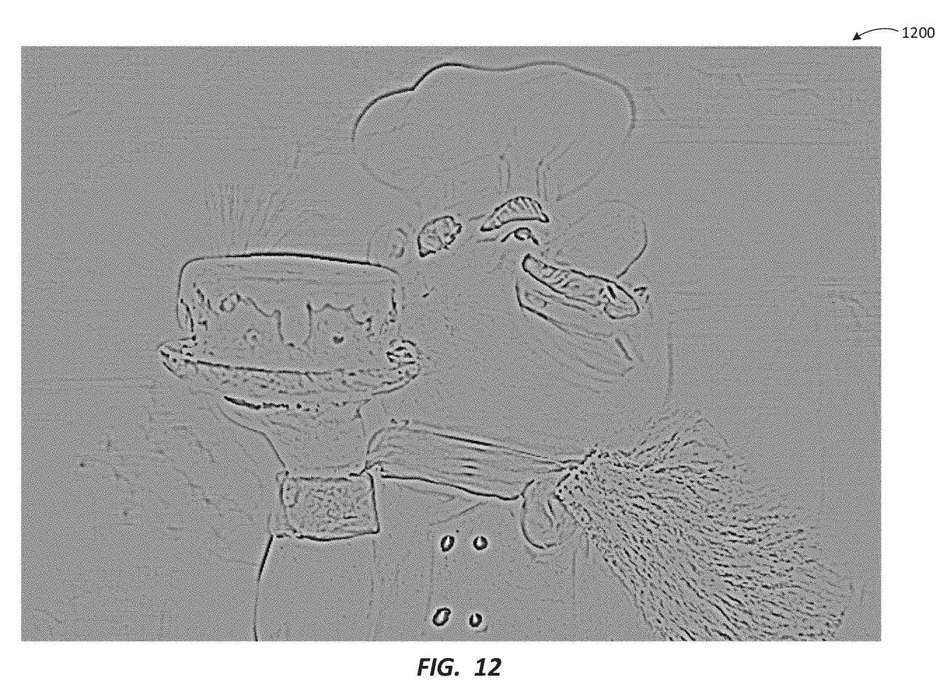

FIG. 12 is a screenshot diagram depicting the processed light-field image 1000 of FIG. 10, after removal of the artifacts identified in the processed modulation light-field image 1100 of FIG. 11 to generate a corrected, processed light-field image 1200, according to one embodiment. The corrected, processed light-field image 1200 may be generated pursuant to the step 560 of the method of FIG. 5. As set forth in the description of the step 560, such correction may be carried out by modifying the pixel values of the processed light-field image 1000 in a manner that reverses and/or negates the artifacts introduced into the processed light-field image 1000 in the course of application of the processing steps. The result may be the generation of the corrected, processed light-field image 1200, in which the artifacts are significantly mitigated and/or removed.

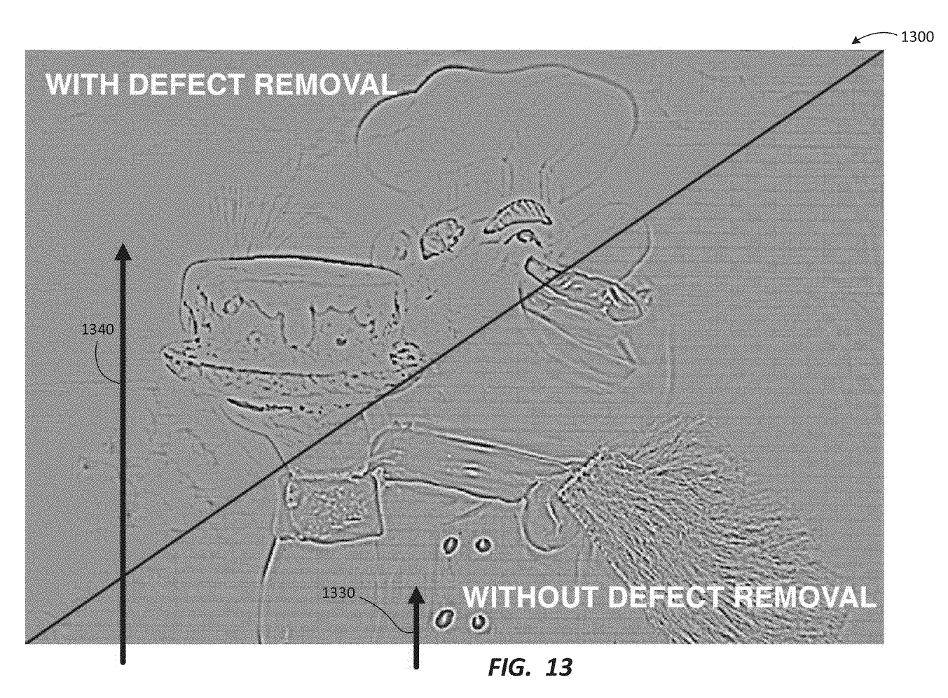

FIG. 13 is a split screenshot diagram 1300 depicting the processed light-field image 1000 of FIG. 10 and the corrected, processed light-field image 1200 of FIG. 12. Specifically, the lower right half 1330 of the screenshot diagram 1300 depicts the processed light-field image 1000 before correction, and the upper left half 1340 of the screenshot diagram 1300 depicts the corrected, processed light-field image 1200. As shown, the horizontal and vertical gridlines and other artifacts are present in the lower right half 1330, but have been removed and/or mitigated in the upper left half 1340. Accordingly, the corrected, processed light-field image 1200 may be more readily used for further processing, such as application of a software-based autofocus algorithm, or display for a user.

The above description and referenced drawings set forth particular details with respect to possible embodiments. Those of skill in the art will appreciate that the techniques described herein may be practiced in other embodiments. First, the particular naming of the components, capitalization of terms, the attributes, data structures, or any other programming or structural aspect is not mandatory or significant, and the mechanisms that implement the techniques described herein may have different names, formats, or protocols. Further, the system may be implemented via a combination of hardware and software, as described, or entirely in hardware elements, or entirely in software elements. Also, the particular division of functionality between the various system components described herein is merely exemplary, and not mandatory; functions performed by a single system component may instead be performed by multiple components, and functions performed by multiple components may instead be performed by a single component.

Reference in the specification to “one embodiment” or to “an embodiment” means that a particular feature, structure, or characteristic described in connection with the embodiments is included in at least one embodiment. The appearances of the phrase “in one embodiment” in various places in the specification are not necessarily all referring to the same embodiment.

Some embodiments may include a system or a method for performing the above-described techniques, either singly or in any combination. Other embodiments may include a computer program product comprising a non-transitory computer-readable storage medium and computer program code, encoded on the medium, for causing a processor in a computing device or other electronic device to perform the above-described techniques.

Some portions of the above are presented in terms of algorithms and symbolic representations of operations on data bits within a memory of a computing device. These algorithmic descriptions and representations are the means used by those skilled in the data processing arts to most effectively convey the substance of their work to others skilled in the art. An algorithm is here, and generally, conceived to be a self-consistent sequence of steps (instructions) leading to a desired result. The steps are those requiring physical manipulations of physical quantities. Usually, though not necessarily, these quantities take the form of electrical, magnetic or optical signals capable of being stored, transferred, combined, compared and otherwise manipulated. It is convenient at times, principally for reasons of common usage, to refer to these signals as bits, values, elements, symbols, characters, terms, numbers, or the like. Furthermore, it is also convenient at times, to refer to certain arrangements of steps requiring physical manipulations of physical quantities as modules or code devices, without loss of generality.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “displaying” or “determining” or the like, refer to the action and processes of a computer system, or similar electronic computing module and/or device, that manipulates and transforms data represented as physical (electronic) quantities within the computer system memories or registers or other such information storage, transmission or display devices.

Certain aspects include process steps and instructions described herein in the form of an algorithm. It should be noted that the process steps and instructions of described herein can be embodied in software, firmware and/or hardware, and when embodied in software, can be downloaded to reside on and be operated from different platforms used by a variety of operating systems.

Some embodiments relate to an apparatus for performing the operations described herein. This apparatus may be specially constructed for the required purposes, or it may comprise a general-purpose computing device selectively activated or reconfigured by a computer program stored in the computing device. Such a computer program may be stored in a computer readable storage medium, such as, but is not limited to, any type of disk including floppy disks, optical disks, CD-ROMs, magnetic-optical disks, read-only memories (ROMs), random access memories (RAMs), EPROMs, EEPROMs, flash memory, solid state drives, magnetic or optical cards, application specific integrated circuits (ASICs), and/or any type of media suitable for storing electronic instructions, and each coupled to a computer system bus. Further, the computing devices referred to herein may include a single processor or may be architectures employing multiple processor designs for increased computing capability.

The algorithms and displays presented herein are not inherently related to any particular computing device, virtualized system, or other apparatus. Various general-purpose systems may also be used with programs in accordance with the teachings herein, or it may prove convenient to construct more specialized apparatus to perform the required method steps. The required structure for a variety of these systems will be apparent from the description provided herein. In addition, the techniques set forth herein are not described with reference to any particular programming language. It will be appreciated that a variety of programming languages may be used to implement the techniques described herein, and any references above to specific languages are provided for illustrative purposes only.

Accordingly, in various embodiments, the techniques described herein can be implemented as software, hardware, and/or other elements for controlling a computer system, computing device, or other electronic device, or any combination or plurality thereof. Such an electronic device can include, for example, a processor, an input device (such as a keyboard, mouse, touchpad, trackpad, joystick, trackball, microphone, and/or any combination thereof), an output device (such as a screen, speaker, and/or the like), memory, long-term storage (such as magnetic storage, optical storage, and/or the like), and/or network connectivity, according to techniques that are well known in the art. Such an electronic device may be portable or nonportable. Examples of electronic devices that may be used for implementing the techniques described herein include: a mobile phone, personal digital assistant, smartphone, kiosk, server computer, enterprise computing device, desktop computer, laptop computer, tablet computer, consumer electronic device, television, set-top box, or the like. An electronic device for implementing the techniques described herein may use any operating system such as, for example: Linux; Microsoft Windows, available from Microsoft Corporation of Redmond, Wash.; Mac OS X, available from Apple Inc. of Cupertino, Calif.; iOS, available from Apple Inc. of Cupertino, Calif.; Android, available from Google, Inc. of Mountain View, Calif.; and/or any other operating system that is adapted for use on the device.

In various embodiments, the techniques described herein can be implemented in a distributed processing environment, networked computing environment, or web-based computing environment. Elements can be implemented on client computing devices, servers, routers, and/or other network or non-network components. In some embodiments, the techniques described herein are implemented using a client/server architecture, wherein some components are implemented on one or more client computing devices and other components are implemented on one or more servers. In one embodiment, in the course of implementing the techniques of the present disclosure, client(s) request content from server(s), and server(s) return content in response to the requests. A browser may be installed at the client computing device for enabling such requests and responses, and for providing a user interface by which the user can initiate and control such interactions and view the presented content.

Any or all of the network components for implementing the described technology may, in some embodiments, be communicatively coupled with one another using any suitable electronic network, whether wired or wireless or any combination thereof, and using any suitable protocols for enabling such communication. One example of such a network is the Internet, although the techniques described herein can be implemented using other networks as well.

While a limited number of embodiments has been described herein, those skilled in the art, having benefit of the above description, will appreciate that other embodiments may be devised which do not depart from the scope of the claims. In addition, it should be noted that the language used in the specification has been principally selected for readability and instructional purposes, and may not have been selected to delineate or circumscribe the inventive subject matter. Accordingly, the disclosure is intended to be illustrative, but not limiting.

What is claimed is:

1. A method for correcting a light-field image to remove artifacts, the method comprising:
in a data store, receiving the light-field image after the light-field image has been captured by a light-field image capture device having an image sensor and a microlens array;
in a processor, applying one or more processing steps to the light-field image to generate a processed light-field image comprising one or more artifacts;
in the data store, receiving a modulation light-field image that depicts no significant features;
in the processor, applying the one or more processing steps to the modulation light-field image to generate a processed modulation light-field image comprising the artifacts;
in the processor, identifying the artifacts in the processed modulation light-field image to generate an identification of the artifacts;
in the processor, using the identification of the artifacts to identify the artifacts in the processed light-field image; and
in the processor, correcting the processed light-field image to remove the artifacts to generate a corrected, processed light-field image.

2. The method of claim 1, wherein the modulation light-field image comprises a light-field image of a uniform flat white scene.

3. The method of claim 2, wherein:
the light-field image comprises a light-field image captured by the light-field image capture device using capture settings; and
the modulation light-field image comprises a modulation light-field image captured by the light-field image capture device using modulation capture settings that are approximately the same as the capture settings.

4. The method of claim 3, further comprising, in the light-field image capture device:
capturing the light-field image using the capture settings; and
capturing the modulation light-field image using the modulation capture settings.

5. The method of claim 4, wherein the one or more artifacts are caused by aliasing of a pattern of microlenses in the microlens array.

6. The method of claim 4, wherein the capture settings comprise a zoom setting of the light-field image capture device.

7. The method of claim 6, wherein the capture settings further comprise a focus setting of the light-field image capture device.

8. The method of claim 1, wherein:
applying the one or more processing steps to the light-field image comprises downsampling the light-field image; and
applying the one or more processing steps to the modulation light-field image comprises downsampling the modulation light-field image.

9. The method of claim 1, wherein:
applying the one or more processing steps to the light-field image comprises applying a filter to the light-field image; and
applying the one or more processing steps to the modulation light-field image comprises applying the filter to the modulation light-field image.

10. The method of claim 1, wherein identifying the artifacts in the processed modulation light-field image comprises applying an autofocus edge detection algorithm to the processed modulation light-field image.

11. A non-transitory computer-readable medium for correcting a light-field image to remove artifacts, comprising instructions stored thereon, that when executed by a processor, perform the steps of:
causing a data store to receive the light-field image after the light-field image has been captured by a light-field image capture device having an image sensor and a microlens array;
applying one or more processing steps to the light-field image to generate a processed light-field image comprising one or more artifacts;
causing the data store to receive a modulation light-field image that depicts no significant features;
applying the one or more processing steps to the modulation light-field image to generate a processed modulation light-field image comprising the artifacts;
identifying the artifacts in the processed modulation light-field image to generate an identification of the artifacts;
using the identification of the artifacts to identify the artifacts in the processed light-field image; and
correcting the processed light-field image to remove the artifacts to generate a corrected, processed light-field image.

12. The non-transitory computer-readable medium of claim 11, wherein the modulation light-field image comprises a light-field image of a uniform flat white scene.

13. The non-transitory computer-readable medium of claim 12, wherein:
the light-field image comprises a light-field image captured by the light-field image capture device using capture settings; and
the modulation light-field image comprises a modulation light-field image captured by the light-field image capture device using modulation capture settings that are approximately the same as the capture settings.

14. The non-transitory computer-readable medium of claim 13, wherein the one or more artifacts are caused by aliasing of a pattern of microlenses in the microlens array.

15. The non-transitory computer-readable medium of claim 13, wherein the capture settings comprise at least one selected from the group consisting of:
a zoom setting of the light-field image capture device; and
a focus setting of the light-field image capture device.

16. The non-transitory computer-readable medium of claim 11, wherein:
applying the one or more processing steps to the light-field image comprises downsampling the light-field image; and
applying the one or more processing steps to the modulation light-field image comprises downsampling the modulation light-field image.

17. The non-transitory computer-readable medium of claim 11, wherein:
applying the one or more processing steps to the light-field image comprises applying a filter to the light-field image; and
applying the one or more processing steps to the modulation light-field image comprises applying the filter to the modulation light-field image.

18. The non-transitory computer-readable medium of claim 11, wherein identifying the artifacts in the processed modulation light-field image comprises applying an autofocus edge detection algorithm to the processed modulation light-field image.

19. A system for correcting a light-field image to remove artifacts, the system comprising:
a data store configured to receive the light-field image after the light-field image has been captured by a light-field image capture device having an image sensor and a microlens array;
a processor, communicatively coupled to the data store, configured to applying one or more processing steps to the light-field image to generate a processed light-field image comprising one or more artifacts;
wherein the data store is further configured to receive a modulation light-field image that depicts no significant features;
and wherein the processor is further configured to:
apply the one or more processing steps to the modulation light-field image to generate a processed modulation light-field image comprising the artifacts;
identify the artifacts in the processed modulation light-field image to generate an identification of the artifacts;
use the identification of the artifacts to identify the artifacts in the processed light-field image; and
correct the processed light-field image to remove the artifacts to generate a corrected, processed light-field image.

20. The system of claim 19, wherein the modulation light-field image comprises a light-field image of a uniform flat white scene.

21. The system of claim 20, further comprising the light-field image capture device, wherein:
the light-field image capture device is configured to capture the light-field image with capture settings applied;
the modulation light-field image was captured with modulation capture settings applied; and
the modulation capture settings are approximately the same as the capture settings.

22. The system of claim 21, wherein the one or more artifacts are caused by aliasing of a pattern of microlenses in the microlens array.

23. The system of claim 21, wherein the capture settings comprise at least one selected from the group consisting of:
a zoom setting of the light-field image capture device; and
a focus setting of the light-field image capture device.

24. The system of claim 19, wherein:
the processor is further configured to apply the one or more processing steps to the light-field image by downsampling the light-field image; and
the processor is further configured to apply the one or more processing steps to the modulation light-field image by downsampling the modulation light-field image.

25. The system of claim 19, wherein:
the processor is further configured to apply the one or more processing steps to the light-field image by applying a filter to the light-field image; and
the processor is further configured to apply the one or more processing steps to the modulation light-field image by applying the filter to the modulation light-field image.

26. The system of claim 19, wherein the processor is further configured to identify the artifacts in the processed modulation light-field image by applying an autofocus edge detection algorithm to the processed modulation light-field image.
